(19) United States
(12) Patent Application Publication
(10) Pub. No.: US 2013/0013544 A1
(43) Pub. Date: Jan. 10, 2013

(54) MIDDLEWARE DEVICE FOR THREE-TIER UBIQUITOUS CITY SYSTEM

(75) Inventor: Yong Woo Lee, Seoul (KR)

(73) Assignee: UNIVERSITY OF SEOUL INDUSTRY COOPERATION FOUNDATION, Seoul (KR)

(21) Appl. No.: 13/636,836

(22) PCT Filed: Mar. 23, 2011
(86) PCT No.: PCT/KR11/02009

§ 371 Date: Sep. 24, 2012

(30) Foreign Application Priority Data
Mar. 23, 2010 (KR) 10-2010-0026014

(51) Int. Cl. G06N 3/04

(52) U.S. Cl. 706/27

(57) ABSTRACT

Disclosed is a ubiquitous city (u-city) exclusive middleware to provide services to a u-city. A middleware device performs a role corresponding to a brain of a human being by aggregating u-city information collected through wired and wireless converged and complex communication networks, analyzes the aggregated information, finds an optimal service based on reasoned current context information and a given command, and processes the found service to be executed. The u-city exclusive middleware performs various embedded functions by operating in a three-tier method through a u-city infrastructure and a u-city portal, and an operating method and executed functions of the middleware follows a method of an operating system of a typical computer system.

### TECHNICAL FIELD

The present invention relates to project No.: “10561”, research project name: “Seoul Industry-Academy-Research Collaboration Project (2005 Technology Infrastructure Construction Project) funded by Seoul City”, and research name: “Development of Intelligent City Information Convergence System for Smart (Ubiquitous) City” as a part of the National Research and Development Project.

The present invention is in regard to a ubiquitous city (u-city) and relates to a u-city system capable of building u-city infrastructures in a three-tier structure, intelligently managing and operating the u-city infrastructures, and providing appropriate intelligent services depending on context information, by using an intelligent u-city middleware system and a u-city portal.

### BACKGROUND ART

A ubiquitous city (u-city) is a city providing a ubiquitous city service anytime and anywhere through ubiquitous city infrastructure facilities constructed using ubiquitous city technology to improve the competitiveness of a city and the quality of life of its inhabitants [excerpt from Section 1, Item 2 of law related to construction of a ubiquitous city, ministry of land transport and maritime affairs]. That is, a u-city is a city that is made, managed, and used through negotiation between an information and communication industry and a construction industry and between city planning and management engineering. A u-city is made by complicated service aggregation in which inter-connected information and communication techniques are supported. A u-city is usually controlled and managed by central management centers, which have various platforms, manage the u-city in a latest u-city communication infrastructure, and provide various services within the u-city.

Referring to Document [1] below, ubiquitous computing is “a post-desktop model of a human-computer interaction in which information processing is perfectly integrated into everyday objects and activities”. A next generation computer communication environment in which anybody can use a service by using any device anytime and anywhere is called a ubiquitous environment. Middleware for supporting a ubiquitous computing environment has been developed. The middleware is developed to aggregate and conveniently provide functions for efficiently using a ubiquitous computing environment. Examples of the middleware are HAVi, Jini, UPnP, LonWork, RCSM, Gaia, Aura, SOCAM, CAMUS, Accord Gaia, SMART, CMQ, and the like.

A u-city uses ubiquitous technologies as infrastructure technology for providing various integrated services for the u-city. These ubiquitous technologies are applied in various patterns to manage city elements of the u-city and provide the integrated services. As an example of on-line banking, although the on-line banking uses basic computer technologies, on-line banking services can be provided by attaching various additional technologies to the basic computer technologies when the basic computer technologies are applied to the on-line banking. Likewise, although a u-city uses basic ubiquitous technologies, new technologies are born by attaching various additional technologies to the basic ubiquitous technologies and provide various integrated u-city services. Since a u-city must convergently manage all city functions and city elements provide integrated services in which city engineering technologies are converged, the typical scheme and concept of ubiquitous middleware cannot be applied to the u-city. In general, a u-city has an extraordinarily large scale. Along with the large scale, limitations for providing integrated services for a real-time u-city are also quite severe. Thus, any one of conventional technologies related to ubiquitous middleware for small-scale ubiquitous devices is not appropriate as middleware for a large-scale u-city. To integratedly and convergently manage the entire city and provide a convergence service, synthetic determination is necessary and may be achieved using information of the entire city while viewing the entire city, and thus, a methodology and an apparatus or system for the synthetic determination are needed but have not been proposed yet. In addition, since every city has different characteristics, a common methodology, apparatus, and system for covering, managing, and operating infrastructures having different characteristics depending on a city to be constructed and operated are necessarily required. Furthermore, when cities are connected and operated, a common methodology, apparatus, and system for covering infrastructures having different characteristics depending on a city, i.e., for commonly operating cities regardless of city infrastructure characteristics, are necessarily required. The present application proposes an intelligent middleware methodology, apparatus, and system for a u-city to solve this problem.

### DETAILED DESCRIPTION OF THE INVENTION

### Technical Problem

The present invention provides ubiquitous middleware for intelligently managing a large amount of remote devices at low cost.

### Technical Solution

According to an aspect of the present invention, there is provided a middleware device operating in a ubiquitous system including a plurality of sensors, which operate in a ubiquitous environment and generate individual sensor signals with individual sensor characteristics, and a plurality of ubiquitous remote resources having individual resource characteristics. The middleware device may include: a common device interface module for receiving the individual sensor signals and converting the individual sensor signals to common sensor signals; a context-aware computing module for reasoning current context information of the ubiquitous environment by analyzing the common sensor signals; and a ubiquitous distributed core computing module, which uses a distributed computing platform adopting a distributed computing technique, determines services performed for the plurality of ubiquitous remote resources, generates individual control signals for controlling the plurality of ubiquitous remote resources based on the determined services, and transmits the generated individual control signals to the plurality of ubiquitous remote resources. In particular, the middleware device may further include a common application interface module for converting the common sensor signals and context information to be compatible with applications executed by a user terminal and providing the converted result to the user terminal. The context-aware computing module may include: a context converter for combining the common sensor signals and converting the combined common sensor signal to a previously defined context instance; a context analyzer for receiving the context instance and reasoning context information by analyzing the received context instance using previously defined rules; and a context provider for providing the context information to the ubiquitous distributed core computing module. The ubiquitous distributed core computing module may include: a service discoverer for searching for a service to be executed from a service repository storing executable services based on context information or receiving the service to be executed from a user; a resource manager for selecting remote resources to be controlled based on a service and generating a common control signal for the selected remote resources; and a resource agent for converting the common control signal to individual control signals by considering individual resource characteristics of the selected remote resources and transmitting the converted individual control signals to the selected remote resources. In particular, the resource agent may be adapted to receive the common control signal for the selected remote resources, acquire information about the characteristics of the selected remote resources from a resource repository, and convert the common control signal to the individual control signals of the selected remote resources based on the information about the characteristics of the selected remote resources.

### Advantageous Effects

According to the present invention, since intelligent middleware operating independently of sensors and remote devices is provided, costs for implementing a ubiquitous city may be significantly reduced, and management costs may also be reduced.

In addition, since the ubiquitous middleware adopts the distributed computing technique, a great amount of sensor information may be real-time processed at low cost, and a user may control remote devices as if the user controlled local resources.

### DESCRIPTION OF THE DRAWINGS

FIG. 1 is a block diagram for describing a concept of a ubiquitous system in which a middleware device operates according to an embodiment of the present invention.

FIG. 2 is a block diagram for describing a concept of a remote management model implemented by the middleware device according to an embodiment of the present invention.

FIG. 3 is a block diagram for describing a concept of a ubiquitous system in which a middleware device operates according to another embodiment of the present invention.

FIG. 4 illustrates pseudo-code showing reasoning rules on which a context-aware computing module performs reasoning with respect to context information.

FIG. 5 is a block diagram for describing a concept of an operation of a middleware device according to an embodiment of the present invention.

FIG. 6 is a diagram illustrating a service ontology used for a service discoverer to determine a service.

### BEST MODE

To fully understand the present invention, operational advantages of the present invention, and objectives obtained by embodiments of the present invention, the attached drawings and contents written in the attached drawings is referred to.

Although exemplary embodiments of the present invention will now be described in detail with reference to the attached drawings, the present invention can be implemented in various different forms and is not limited to these embodiments. Parts irrelevant to the description are omitted to clearly describe the present invention, and like reference numerals denote like elements throughout the drawings.

In the specification, when a certain part “includes” a certain component, this indicates that the part may further include another component instead of excluding another component unless there is no different disclosure. In addition, terms, such as “. . . unit,” “ . . . er/or,” “module,” or “block,” disclosed in the specification indicates a unit for processing at least one function or operation, and this may be implemented by hardware, software, or a combination of both.

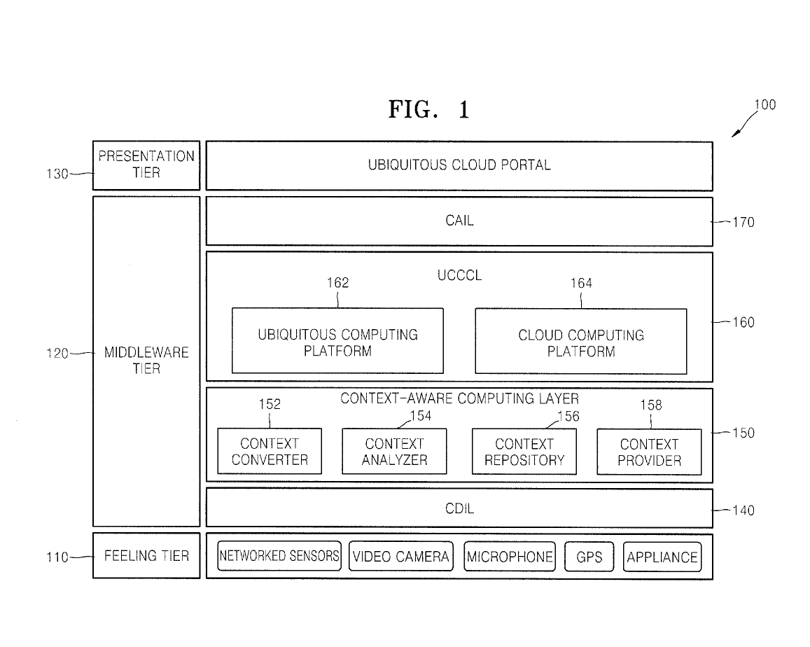

FIG. 1 is a block diagram for describing a concept of a ubiquitous system 100 in which a middleware device operates according to an embodiment of the present invention.

Referring to FIG. 1, the ubiquitous system 100 consists of three tiers, which include a feeling tier 110, a middleware tier 120, and a presentation tier 130. An apparatus for implementing the middleware tier 120 is the middleware device.

The feeling tier 110 includes various devices, such as network sensors, a video camera, a microphone, a Global Positioning System (GPS) sensor, and appliances. The middleware tier 120 includes four layers of a common device interface layer (CDIL) 140, a context-aware computing layer 150, a ubiquitous cloud core computing layer (UCCCL) 160, and a common application interface layer (CAIL) 170. The context-aware computing layer 150 includes a context converter 152, a context analyzer 154, a context repository 156, and a context provider 158, and the ubiquitous cloud core computing layer 160 includes a ubiquitous computing platform 162 and a cloud computing platform 164.

The middleware tier 120 according to the present invention is a core technique for providing various integrated services for a u-city (refer to Document [14]). Decisions for operating the u-city must be made by efficiently cooperative individuals or groups, and temporally related data in the u-city must be processed in real-time. The middleware tier 120 functions as an intermediary platform between ubiquitous applications for the u-city and functions as an infrastructure of the u-city and includes services by which various ubiquitous applications can manage the u-city. In addition, the middleware tier 120 has a cloud platform concept so that application programs do not have to consider details of the middleware tier 120. That is, since applications for the u-city use the common middleware tier 120, time and cost are reduced to develop the u-city applications, the u-city can be operated and managed more systematically and effectively, and consistency of the application programs are ensured.

In the embodiment shown in FIG. 1, individual sensor signals received from the sensors are transmitted to the common device interface layer 140 of the middleware tier 120. In the specification, a ubiquitous environment indicates that a plurality of sensors and remote resources having various characteristics are connected to a central monitoring and control unit or a central server for providing ubiquitous services in various communication schemes. The central server is equipped with the middleware device according to the present invention to process a great amount of sensor information and control remote resources based on current context information. In addition, in the present invention, sensor characteristics indicate properties unique to each sensor, such as physical characteristics of the sensor, a communication protocol applied to a signal transmitted from the sensor, and physical characteristics of the sensor signal. Although sensors transmitting a sensor signal using the same communication protocol may be connected to the same Ubiquitous Sensor Network (USN), the present invention is not limited thereto, and various sensors using various communication protocols may be commonly connected to the central server. In addition, in the specification, remote devices or remote resources indicate various devices operating to implement services determined based on context information. For example, if a service for opening sluice gates is determined, a remote resource may be a sluice gate driving device. Each of the remote devices may also have unique physical characteristics like sensors and communicate with the central server using a unique communication protocol. Physical characteristics of control signals for controlling the remote devices may also be included in characteristics of the remote devices. For example, more electric power is consumed to control a sluice gate opening/closing device for opening and closing a large sluice gate than a sluice gate driving device for opening and closing a small sluice gate. For clarity in the present invention, a signal for controlling all remote devices is called a common control signal, and a definite signal for controlling each of the remote devices is called an individual control signal. For example, a control signal for commanding small- and large-sluice gate opening/closing devices to open small and large sluice gates by 50% is a common control signal, and definite physical signals for the small- and large-sluice gate opening/closing devices to drive sluice gate opening/closing motors based on the common control signal are individual control signals.

When an individual sensor signal is generated, the common device interface layer 140 converts the individual sensor signal to a common sensor signal by considering corresponding sensor characteristics and transmits the converted common control signal to the context-aware computing layer 150. That is, even though the common device interface layer 140 is connected to various types of devices, the common device interface layer 140 provides a consistent and unified interface to the context-aware computing layer 150 and the ubiquitous cloud core computing layer 160. That is, since the middleware tier 120 supports sensor network data synchronization and protocols, the middleware tier 120 may be used as a typical gateway for various types of sensors and a ubiquitous sensor network. The sensing tier 110 includes heterogeneous sensors for aggregating data in a u-city environment. In the specification, the reason for converting each individual sensor signal to a common sensor signal is to analyze a sensor signal in middleware independently to characteristics of each sensor. For example, even though cameras having different charge-coupled devices (CCDs) are exposed to the same light intensity, light intensity sensed by the cameras differs from each other. In this case, an absolute magnitude of light intensity received by each camera may be an individual sensor signal, and a ratio of current light intensity to the maximum received light intensity may be a common sensor signal. As such, an operation of generating a common sensor signal may be an operation of normalizing an individual sensor signal by considering characteristics of each sensor. As described above, since the middleware device uses characteristics of each sensor and an independent common sensor signal, the middleware device may independently operate regardless of actual characteristics of individual sensors, and sensors may be easily added if necessary.

The middleware tier 120 operates as a Platform-as-a-Service (PaaS) to perform ontology-based intelligent context-aware processing. The common sensor signal received from the common device interface layer 140 is transmitted to the context-aware computing layer 150. Then, the context converter 152 converts the received common sensor signal to a context instance so that other components may use the context instance. The context instance is transmitted to the context analyzer 154, and the context analyzer 154 performs reasoning with respect to context information from a domain ontology previously determined by applying reasoning rules stored in the context repository 156. In this case, the context analyzer 154 uses an ontology-based intelligent reasoning engine and uses the domain ontology previously determined to manage context data. The reasoned context information is transmitted to the ubiquitous cloud core computing layer 160 by the context provider 158.

The ubiquitous cloud core computing layer 160 performs intelligent services, such as automatic service discovery, automatic service distribution, and automatic service execution, based on a context reasoned by the context-aware computing layer 150 so that an automatic computing environment is provided and application programs or services can be used in a timely and cooperative method anywhere. Since a previously defined service in an application is provided, information received from other devices or environments may be integrated.

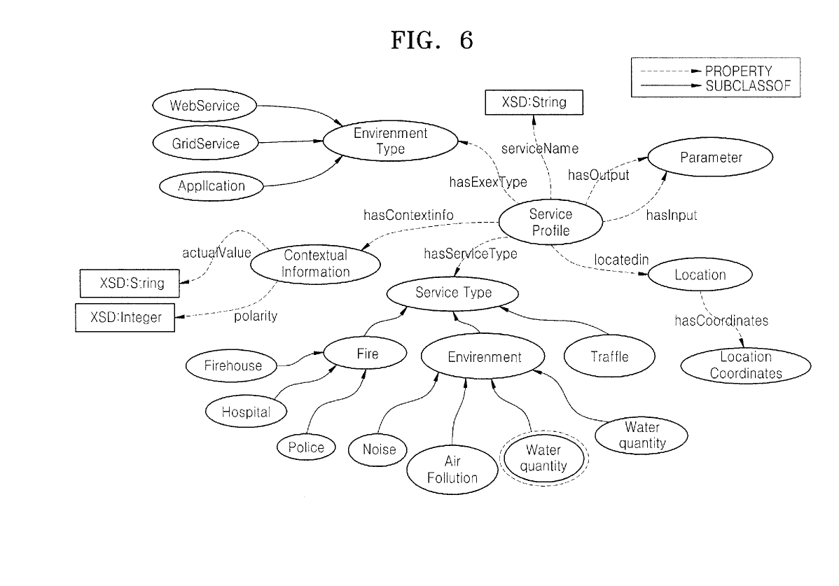

The ubiquitous computing platform 162 receives the context information from the context provider 158 and may select a service to be executed from a service ontology by using the context information. The service ontology may be implemented as shown in FIG. 6. The cloud computing platform 164 provides a user-transparent service through the presentation tier 130. That is, the cloud computing platform 164 provides computing power to an application demanding real-time high-performance computing power by using a computing grid technique. In addition, the cloud computing platform 164 provides a Computer Supported Cooperative Work (CSCW) service using an access grid technique. Thus, the cloud computing platform 164 may real-time control a large amount of remote devices, such as a firewall, an emergency device, and a remote camera.

The common application interface layer 170 converts common sensor signals, which are common for different types of applications such as a fire management application and a traffic accident management application, and context information and provides the converted result to the presentation tier 130. The common application interface layer 170 converts the common sensor signals and the context information to be compatible with not only different applications executed by the same user terminal but also different user terminals and provides the converted result to the presentation tier 130. That is, the user may execute various applications on various user terminals through the common application interface layer 170 to read current context information of a ubiquitous environment and give a required user command.

The presentation tier 130 provides intelligent services, computing power, and an infrastructure to various types of applications used by the user. In addition, the presentation tier 130 may provide a portal for various applications, a portal for controlling a remote device, and a portal for managing context awareness. The user may conveniently and easily use a ubiquitous service and a cloud service by using the presentation tier 130.

To control remote devices, it is necessary for the user not to feel a difference between the remote devices and local devices, and to this end, the middleware device performs remote control using cloud computing. Distributed computing for the remote control needs to satisfy the following conditions:
New standard user interface capable of remote use through a network to replace an interface provided by existing control software
Standard control protocol for controlling local remote devices
Remote monitoring system capable of remote and real-time observing of device management to be performed and of data generated by devices and observation sensors
Software supporting automatic remote management when it is necessary to pre-program and automatically execute a complicated management proceeding process
Tool for real-time exchanging of information with a plurality of managers physically apart from each other in a manager community.

A distributed computing scheme is used in the present invention because a sensor network and a remote device network of as large a scale as anticipated to facilitate innovation in a next generation Information Technology (IT) field can be effectively managed at low cost.

### MODE OF THE INVENTION

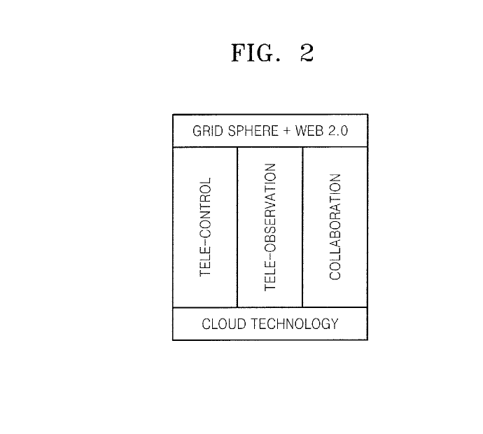

A remote management model adopted in the present invention will now be described with reference to FIG. 2.

FIG. 2 is a block diagram for describing a concept of a remote management model implemented in the present invention.

For remote control, a Globus Tele-Control Protocol (GTCP) is used as a remote control protocol in a Globus Toolkit 4 (refer to Documents [17] and [18]). The GTCP provides methods such as openSession, closeSession, propose, execute, cancel, and the like.

In addition, a real-time monitoring system for remote devices is provided for remote monitoring. A remote monitoring module provides video images to view data measured from each sensor and a state of each device. For a data streaming service, a Ring Buffer Network Bus (RBNB) Data Turbine (refer to Document [10]) performs this role in a Network for Earthquake Engineering Simulation Grid (NEESgrid) (refer to Document [7]), and software NaradaBroker (refer to Document [12]) performs this role in a High-Voltage Electron Microscopy Grid (HVEMgrid) (refer to Document [11]).

Although a user interface for remote control, remote monitoring, and cooperation may be implemented in various forms, it is preferable that the user interface is provided in the form of a web portal. Gridsphere provides a user interface function in the form of a portlet that is a JSR-168 specification standard. In addition, gridsphere dynamically represents a device control point, a sensor, and the like using web 2.0 technology based on Java Script on a web so as to be easily used by a user.

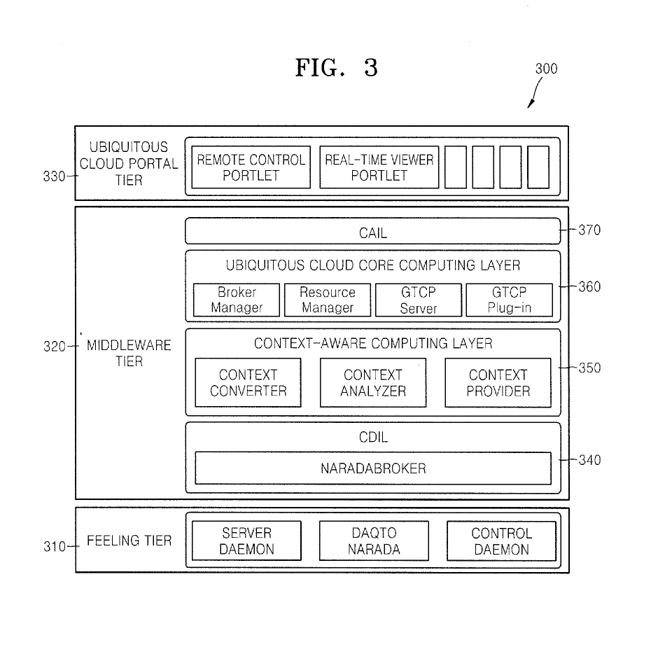

FIG. 3 is a block diagram for describing the concept of a ubiquitous system 300 according to another embodiment of the present invention.

Referring to FIG. 3, the ubiquitous system 300 includes a feeling tier 310, a middleware tier 320, and a ubiquitous cloud portal tier 330. A middleware device according to the current embodiment is implemented in the middleware tier 320.

The feeling tier 310 includes a plurality of sensors, which operate in a ubiquitous environment, have individual sensor characteristics, and generate individual sensor signals, and a plurality of ubiquitous remote resources having individual resource characteristics. In more detail, each remote Ubiquitous Sensor Network (USN) includes LabView (refer to Document [21]), a server daemon, DaqToNarada, and a control daemon therein. The feeling tier 310 receives data from sensors, a video camera, and an audio device, cooperatively processes the received data, and transmits the processed data to NaradaBroker in a common device interface of a Tier 2.

The server daemon in a remote system receives individual sensor signals from sensors through the LabView. In addition, the server daemon transmits the received data to the DaqToNarada. Then, the DaqToNarada in the remote system transmits the data to the NaradaBroker. The DaqToNarada and the NaradaBroker cooperate with each other for data streaming. In addition, the control daemon receives a control signal from a GTCP plug-in included in a ubiquitous cloud core computing layer 360. The control daemon controls remote devices based on a request from the ubiquitous cloud portal tier 330 or a command according to an emergency scenario in the middleware tier 320. In this case, the control daemon controls remote devices based on common control signals regardless of characteristics of each of the remote devices as described above.

In addition, the middleware tier 320 includes a common device interface layer (CDIL) 340, a context-aware computing layer 350, the ubiquitous cloud core computing layer 360, and a common application interface layer (CAIL) 370.

A context converter included in the context-aware computing layer 350 converts a raw data value received from each of various types of remote devices via the NaradaBroker to a specific context instance. The converted context instance is stored in a domain ontology formed by information classes. Here, one piece of context data is identical to an individual instance in a context domain ontology model. This changed context information is used by other components for intelligent context-aware cloud computing.

A context analyzer provides context information reasoned based on a domain ontology using a reasoning engine suitable for a context. Several reasoning engines may cooperate with the context analyzer to provide various reasoning results. The reasoning engine in the context analyzer has a function of providing reasoned context information based on a direct context and a function of reasoning a difference between details in a context knowledge database. A pre-set-rule-based method is used to perform reasoning of current context information.

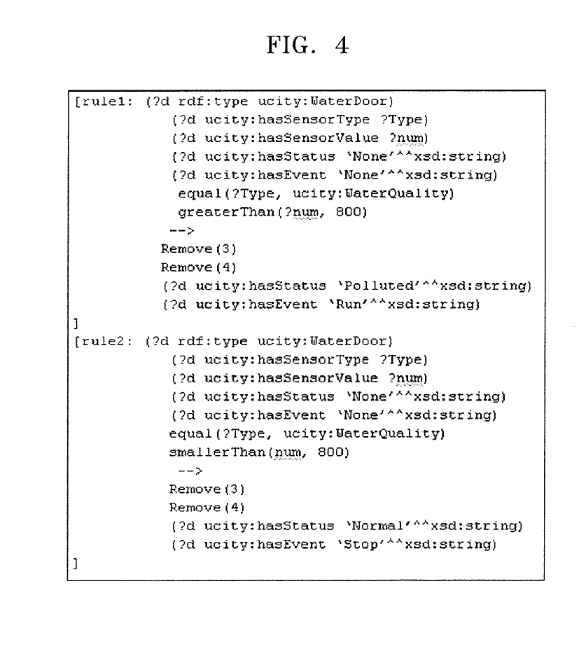

FIG. 4 illustrates pseudo-code showing reasoning rules on which a context-aware computing module performs reasoning with respect to context information.

If electrical conductance of water exceeds 800, it is reasoned that the water is contaminated by toxic chemicals. In this case, a water pump is enabled according to a result of the reasoning. The context analyzer in the context-aware computing layer 350 performs reasoning on whether the water is contaminated at present, and a service discoverer (not shown) discovers a pump enabling service or a service of notifying an associated manager of a specific warning message from a service ontology using the reasoned context information.

Four major components, a broker manager, a resource manager, a GTCP server, and the GTCP plug-in, in the middleware tier 320 cooperate with each other to implement remote management. The broker manager determines which one of remote control services is provided to a remote device. The determined service may be displayed on a screen of a user via the ubiquitous cloud portal tier 330 and perform an already defined action. When the context analyzer is aware of an exceptional context, the broker manager is warned by the context provider. The broker manager transmits the determination to the resource manager. The GTCP server and the GTCP plug-in cooperatively operate to perform remote control according to the determination and may use GT4 (refer to Document [17]). The GTCP server receives an instruction of the user from a cloud portal and transmits the received instruction to the GTCP plug-in.

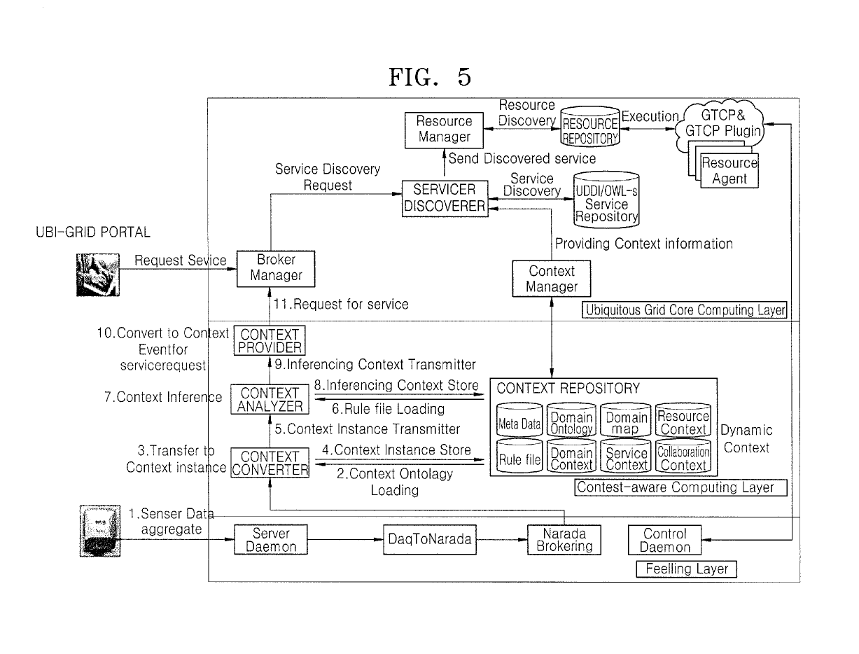

FIG. 5 is a block diagram for describing the concept of an operation of a middleware device according to an embodiment of the present invention.

Referring to FIG. 5 data measured by sensors and video/audio images received from video/audio devices are aggregated by a server daemon of a computer system. The server daemon transmits this information to the DaqToNarada in the computer system. The DaqToNarada transmits the aggregated data to the NaradaBroker. The NaradaBroker transmits the measured data to a context converter. The video data is directly transmitted to a real-time view portlet in a ubiquitous cloud portal by the NaradaBroker.

The context converter converts the measured data to an ontology instance and transmits the converted ontology instance to a context analyzer. A reasoning engine of the context analyzer performs reasoning with respect to a pre-defined context using the received ontology instance and pre-defined rules. The context analyzer transmits the reasoned context to a broker manager. Upon receiving the reasoned context, the broker manager transmits the received context to the real-time view portlet in the ubiquitous cloud portal. If the received context information needs a specific service, a service discoverer searches for an appropriate service.

If the found service needs to control a remote device, the broker manager transmits a request of the found service to a resource manager. The resource manager cooperates with a GTCP to transmit a control command to a control daemon in a remote computer system connected to the remote device. The remote device is controlled by the control daemon.

FIG. 6 is a diagram illustrating a service ontology used for the service discoverer to determine a service.

A context provider provides reasoned context information to the ubiquitous cloud core computing layer 360 to discover a service. The discovered service is executed by a cloud computing platform or a ubiquitous computing platform. In addition, a context repository stores contexts, an ontology, context instances, rules shown in FIG. 6, and reasoned context information. Other components may query, add, delete, and update context knowledge using the context repository.

As described above, the middleware device uses a cloud computing platform and is implemented in a three-tier structure. Thus, user transparence that a user does not have to be aware of an infrastructure or to know details about the remote control principle is provided. In addition, since the middleware device uses the PaaS concept, devices located at a remote place may be felt and controlled by virtualizing the devices as if the devices were located at a local place. While remote control models according to the prior art control only one specified remote device, the middleware device may manage various types of heterogeneous remote devices.

A u-city system to which the present invention is applied includes three tiers such as a u-city infrastructure system (tier 1), an intelligent u-city middleware system (tier 2), and a u-city portal system (tier 3). To operate the three-tier system for a u-city, the intelligent u-city middleware system (tier 2) and the u-city portal system (tier 3) or a user interface system for delivering a result to a user in another way other than the u-city portal system are disclosed.

The u-city infrastructure system includes city components forming a u-city and IT devices and is the tier 1. The tier 1 allows the u-city components to operate by being connected to each other as if the u-city components were a single organism like a human neural network by connecting them to all available communication networks, such as wired, wireless, analog, and digital communication networks in a complex communication method including all available communication mechanisms.

The tier 2 includes a software section having an intelligent middleware function and a server that is a hardware device for operating the software section and may be called an intelligent u-city middleware system. The intelligent u-city middleware system (tier 2) is connected to the u-city infrastructure system (tier 1) via a complex communication network including wired communication networks and wireless communication networks and various types of complex communication mechanisms so that various kinds of information for the u-city are smoothly exchanged between the tier 1 and the tier 2 as in a human neural network.

The tier 2 has a similar role as that of a brain in a human being. That is, the tier 2 synthesizes all information received from the infrastructure of the u-city, determines contexts, performs most timely actions based on the determination, converges all the information, and provides high value-added useful information and services to the u-city infrastructure system (tier 1) and u-city users of the tier 3. The provided information and services may be provided via the u-city portal system or directly. The intelligent u-city middleware system is different from a u-city platform in that the intelligent u-city middleware system operates intelligently like a human brain.

The intelligent u-city middleware system includes: a common connection section for connecting various devices to the tier 2 to be able to connect any device or platform in the tier 1 to the tier 2, receive information from them, and transmit information and services to them; a context-aware section for functioning to perform mutual information communication by receiving the information from the common connection section to perceive a current context, transmitting the perceived context to a next stage, and receiving information from the next stage to transmit the received information to the common connection section in a previous stage; a u-city converged and complex information processing section, which includes various types of latest information processing mechanisms such as cloud computing, grid computing, image processing, various types of two-dimensional and three-dimensional geographic information system (GIS) information processing, and services for controlling remote devices, convergently creates and provides optimal services and information depending on context determination, and performs mutual information communication by transmitting the services and information to a next stage, and receiving information from the next stage and transmitting the information to a previous stage; and a common connection section for the tier 3.

A common connection module for the tier 3 provides a connection method so that any connection method in the tier 3 can be accepted by the intelligent u-city middleware system. For example, the common connection section for the tier 3 provides a connection method so that a u-city portal function in the tier 3 can be performed on various applications in the tier 3, such as environment applications including a water management application and an air management application and fire incident processing applications, typical terminals, and various mobile terminals to realize the ubiquitous concept. The common connection section for the tier 3 also performs mutual information communication by transmitting information and services to a next stage, and receiving information from the next stage and transmitting the information to a previous stage.

The tier 3 includes the u-city portal system or the user interface system for delivering a result to a user in another way other than the u-city portal system. Unlike typical portal systems, the u-city portal system includes an application section and a u-city system support section. In addition, the u-city portal system is able to be performed on typical terminals and various types of mobile terminals to construct a ubiquitous environment for a u-city.

As described above, in a similar manner to a human being in everyday life operating an organically connected body in response to determination and instructions of a brain, the entire u-city operates an infrastructure (tier 1) and a u-city portal and a system for delivering final information and services to users (tier 3) that are organically connected to the intelligent u-city middleware system (tier 2) in a converged and complex system in response to determination and instructions of the intelligent u-city middleware system (tier 2) through the systems in the tier 1, the tier 2, and the tier 3 so that users may enhance their everyday life in a u-city.

According to a u-city system to which the present invention is applied, regions to be included in a u-city and types of converged and complex information and services may be efficiently and systematically extended at economical cost without duplicated costs.

In addition, since an intelligent integrated middleware for the u-city and a u-city portal are provided, the cost of realizing the u-city may be significantly reduced, management and operating costs may also be reduced, and compatibility between u-cities is possible.

In addition, u-city functions may be easily added, updated, or continuously improved. An intelligent u-city middleware functioning as a brain in a human being is used to manage and operate the entire u-city as if the entire u-city were a single organism.

The u-city system to which the present invention is applied may be applied to construction, management, and operation of a u-city. An intelligent u-city middleware system may be used for a synthesized control center, thereby making intelligent management and operation possible and creating various derived industries. In addition, the intelligent u-city middleware system allows companies and experts not participating in the construction, management, and operation to easily realize good ideas regarding improving quality of life, and a u-city portal promotes a chance that anybody can conveniently use products realized in a u-city, thereby eventually contributing to revitalization of the market and related industries.

According to the present invention, disclosed is a middleware device for a u-city system including a plurality of sensors operating in a ubiquitous environment to collect and converge current u-city information, execute a command of a manager that is directed through a u-city portal, derive and provide intelligent services required for the u-city based on an embedded command in a similar manner to a human brain determining a situation and directing a body of a human being in everyday life, and integratedly operate the u-city based on a method in which an operating system of a computer system operates the computer system. The u-city system includes a u-city infrastructure section having a plurality of sensors and u-city resources; and a u-city portal providing section for receiving information related to the services from an intelligent u-city middleware section and displaying the information on a terminal to allow a user to be able to control the u-city resources, and for providing a control command of the user to the intelligent u-city middleware section, wherein the middleware device for the u-city system performs a role corresponding to a brain of a human being by aggregating u-city information collected through wired and wireless converged and complex communication networks, analyzes the aggregated information, finds an optimal service based on reasoned current context information and a given command, and processes the found service to be executed. U-city exclusive middleware performs various embedded functions by operating in a three-tier method through a u-city infrastructure and a u-city portal and is characterized in that an operating method and executed functions of the middleware follow a method of an operating system of a typical computer system.

In addition, the middleware device according to the present invention includes at least one of: a sensor and sensor network manager for managing sensors and sensor networks connected to the middleware device; a network manager for monitoring and managing a converged and complex network connected to the middleware device; an ad-hoc network manager for monitoring and managing a converged and complex ad-hoc network connected to the middleware device; a video manager for managing a video camera connected to the middleware device and enabling scalable video data streaming; a remote device manager for controlling remote devices connected to the middleware device; a remote cooperative work manager for allowing geographically distributed users connected to the middleware device to perform cooperative work in remote areas; an intelligent information processing manager for processing intelligent information in a context-aware computing method by using context information in the middleware device; a service discovery and execution manager capable of discovering and executing a service using ontology-based semantic matchmaking in the middleware device; a grid computing manager and cloud computing manager for managing a supply of computing power to an execution process in the middleware device; a spatial geographic information (GIS information) manager for two-dimensionally or three-dimensionally visualizing representation information by converging the representation information with spatial geographic information (GIS information); and a location recognition manager for managing information provided from a location based system (LBS) to be converged with typical information.

Using the present patent technology, regions to be included in a u-city and types of converged and complex information and services may be efficiently and systematically extended at economical cost without duplicated costs, and since intelligent integrated middleware for the u-city may be used together with a u-city portal, the cost of realizing the u-city may be significantly reduced, management and operating costs may also be reduced, and compatibility between u-cities is possible. In addition, u-city functions may be easily added, updated, or continuously improved. The the inventive concept described herein may be used for a u-city synthesized control center, and allow the entire u-city to be managed and operated like a single organism by using intelligent u-city middleware functioning in a similar manner as a brain in a human being.

While the present invention has been described with reference to embodiments shown in the accompanying drawings, the embodiments are only illustrative, and it will be understood by one of ordinary skill in the art that various modifications and equivalent other embodiments may be made therefrom. Therefore, the technical scope of the present invention should be defined by the technical spirit of the following claims.

### INDUSTRIAL APPLICABILITY

The present invention may be applied to ubiquitous systems for real-time reasoning of context information by real-time processing sensor signals received from a large-scale sensor network and controlling remote devices depending on the result of the reasoning.

The documents below are incorporated herein in their entirety by reference.

[1] B. Hayes, “Cloud Computing”, Communications of The ACM, July 2008, pp. 9-11.

[2] I. Foster, Y. Zhao, I. Raicu, and S. Lu. “Cloud Computing and Grid Computing 360-Degree Compared”. Grid Computing Environment Workshop(GCE'08), 2008.

[3] R. Grossman. “The Case for Cloud Computing”. ITPro, 2009, pp. 23-27.

[4] G. DeCandia, D. Hastorun, M. Jampani, G. Kakulapati, A. Lakshman, A. Pilchin, S. Sivasubramanian, P. Vosshall, and W. Vogels. “Dynamo: Amazons highly available keyvalue store”. In SOSP, 2007.

[5] Amazon Elastic Compute Cloud (Amazon EC2).http://aws.amazon.com/ec2.

[6] Google app engine web site, http://code.google.com/intl/appengine/.

[7] H. S. Jung, C. S. Jeong, Y. W. Lee, and P. D. Hong, “An Intelligent Ubiquitous Middleware for U-City : SmartUM” JOURNAL OF INFORMATION SCIENCE AND ENGINEERING 25, 2009, pp. 375-388.

[8] H.S. Jung, J. K. Baek, C. S. Jeong, Y. W. Lee, and P. D. Hong, “Unified Ubiquitous Middleware for U-City”, 2007 IEEE International Conference on Convergence Information Technology (2007 ICCIT), 2007.

[9] H. Han, H. Jung, H. Y. Yeom, H. S. Kweon, and J. Lee “HVEM Grid: Experiences in Constructing an Electron Microscopy Grid”, APWeb 2006, 2006.

[10] NCMIR, http://www-ncmir.ucsd.edu/.

[11] UHVEM, http://www.uhvem.osaka-u.ac.jp/.

[12] NEES Inc, http://www.nees.org.

[13] KOCED, http://www.koced.net/.

[14] M. Weiser, “The Computer for the Twenty-First Century”, Scientific American, 1991, pp. 94-101.

[15] A. R. C. da Rocha, M. Endler, and T. S. de Siqueira. “Middleware for Ubiquitous Context-Awareness”, MPAC, 2008.

[16] C. Liao, Q. Liu, D. Kimber, P. Chiu, J. Foote, and L.Wilcox, “Shared interactive video for teleconferencing”. MULTIMEDIA: Proceedings of the eleventh ACM international conference on Multimedia, 2003.

[17] The globus toolkit, http://www.globus.org/tookit/

[18] I. Foster. “Globus Toolkit Version 4: Software for Service-Oriented Systems.”. IFIP Int. Conf. on Network and Parallel Computing, Springer-Verlag LNCS 3779, 2006, pp 2-13.

[19] Hanover, N H, “Ring Buffered Network Bus Technology Framework for Knowledge-Based System-of-Systems”, RBNB DataTurbine Documents, Creare Inc. (unpublished), 2001.

[20] NaradaBroker, http://www.naradabrokering.org/.

[21] National instruments LabVIEW, http://www.ni.com.

1. A middleware device for a three-tier ubiquitous city (u-city) system comprising a plurality of sensors operating in a ubiquitous environment to collect and converge current u-city information, execute a command of a manager that is directed through a u-city portal, derive and provide intelligent services required for a u-city based on an embedded command in a similar manner to a human brain determining a context and directing a body of a human being in everyday life, and integratedly operate the u-city based on a method in which an operating system of a computer system operates the computer system,
the u-city system comprising:
a u-city infrastructure section having a plurality of sensors and u-city resources; and
a u-city portal providing section for receiving information related to the services from the middleware device and displaying the information on a terminal to allow a user to be able to control the u-city resources, and for providing a control command of the user to the intelligent u-city middleware section,
wherein the middleware device for the u-city system performs a role corresponding to a brain of a human being by aggregating u-city information collected through wired and wireless converged and complex communication networks, analyzes the aggregated information, finds an optimal service based on reasoned current context information and a given command, processes the found service to be executed, and performs various embedded functions by operating in a three-tier method through the u-city infrastructure section and the u-city portal providing section, and an operating method and executed functions of the middleware device follow a method of an operating system of a typical computer system.

2. The middleware device of claim 1, wherein the middleware device comprises at least one of:
a sensor and sensor network manager for managing the sensors and sensor networks connected to the middleware device;
a network manager for monitoring and managing a converged and complex network connected to the middleware device;
an ad-hoc network manager for monitoring and managing a converged and complex ad-hoc network connected to the middleware device;
a video manager for managing a video camera connected to the middleware device and enabling scalable video data streaming;
a remote device manager for controlling remote devices connected to the middleware device;
a remote cooperative work manager for allowing geographically distributed users connected to the middleware device to perform cooperative work in remote areas;
an intelligent information processing manager for processing intelligent information in a context-aware computing method by using context information in the middleware device;
a service discovery and execution manager capable of discovering and executing a service using ontology-based semantic matchmaking in the middleware device;
a grid computing manager and cloud computing manager for managing a supply of computing power to an execution process in the middleware device;
a spatial geographic information (GIS information) manager for two-dimensionally or three-dimensionally visualizing representation information by converging the representation information with spatial geographic information (GIS information); and
a location recognition manager for managing information provided from a location based system (LBS) to be converged with typical information.
